(19) United States
(12) Patent Application Publication
(10) Pub. No.: US 2017/0055495 A1
(43) Pub. Date: Mar. 2, 2017

(54) The Coolsnake

(71) Applicant: Michael Atkins, Greenwich, CT (US)

(72) Inventor: Michael Atkins, Greenwich, CT (US)

(21) Appl. No.: 14/840,681

(22) Filed: Aug. 31, 2015

(51) Int. Cl. A01K 7/00; A01K 27/00

(52) U.S. Cl. CPC A01K 7/00; A01K 27/001

(57) ABSTRACT

A liquid receptacle and water reservoir in combination with a pet collar is provided by the present invention. The water reservoir is comprised of: a tubular shaped water reservoir provided with a first orifice for filling said reservoir with fluid and a second orifice for dispensing the fluid from said reservoir, a plurality of reflective strips applied to the surface of said water reservoir, a standard choke and harness attachment provided for attaching said water reservoir with the body of an animal, a spigot-type dispensing member provided from said second orifice for assisting the dispensing of the fluid from said water reservoir, and a receptacle connecting the reservoir to said dispensing device.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates generally to pet collars, and, more particularly, to a petcollar that is specifically designed to hold drinking water for the pet.

(2) Background of the Invention

It is believed that dogs were the first animal to be domesticated by man. Dogs have many useful purposes. For instance, dogs have been and continue to be used for hunting, herding, guiding, and guarding. However, most dogs today serve primarily as companions or as pets. Consequently, dogs are frequently referred to as “man's best friend.”

Dogs are especially prone to overheat in warm weather because they can't sweat through most of their skin like humans do. Furthermore, their fur traps heat. Instead, dogs cool themselves by panting, the excess heat being carried away by water evaporating from their airway and mouth. Short-nosed dogs are most prone to overheat, because their shorter airways are less effective at cooling. The water lost to evaporation then needs to be replaced, and, even in the cooler months, active dogs need water to replenish losses due to the low humidity.

It is common for dogs to accompany their owners while engaging in such activities as walking, biking, or jogging. Dogs offer both companionship and protection during these activities. In warm seasons, the dogs may become thirsty while accompanying their owner. Depending upon the location, there may not be a readily available source of clean drinking water for the dog. Even if a source of water were available, such as a water fountain in a park, there may not be a suitable container present to put drinking water in for the dog. In the past, harnesses have been devised to allow animals to carry food and/or beverages.

Various hydration devices for dogs or other companion animals have been proposed, including a variety of water bottles with attached bowls, hydration collars, and backpacks wearable by dogs, such as U.S Pat. No. 5,184,762 to Nevitt Bryant D, U.S. Pat. No. 4,805,619 to Swearingen David W. U.S. Pat. No. 6,516,748 to Heather Jackson, U.S. Pat. No. 6,418,881 to Antoinette Marie Starratt, U.S. Pat. No. 5,890,637 to Furneaux Lloyd, U.S. Pat. No. 6,581,811 to Simon Schillaci U.S. Pat. No. 8,708,194 to Amanda R. Pascatore, U.S Patent Application No. 20040250778 to Bennis Jacqueline A., Susan Skramstad, 20110061607 of Marley's Mates, LLC, 20070213794 to Lauver Diana L. and 20130298838 to Cesar Belmonte and Eduardo Talbert. However, it is found from prior searches that water bottles lack storage for other supplies, such as treats, keys, and badges required by many localities. Usually clipped to a belt, these bottles must be unclipped and unfolded to provide water to the animal. Hydration collars and backpacks may pose difficulty for small dogs that can't carry as much, so transporting water on the dog may not be a practical option for smaller breeds. Therefore, there exists a need for a convenient means for carrying and providing water for dogs that combines storage and hydration functions, and is suitable for use with both large and small breeds.

Accordingly, there continues to be a need for a device that allows dogs to carry their own drinking water and that provides a suitable container from which the dog can drink.

### SUMMARY OF THE INVENTION

The present invention solves some of the aforementioned problems by providing a liquid receptacle and water reservoir combined with a pet collar, which is specifically designed to be worn around the neck of a pet, to hold drinking water for an animal, such as a dog. The reservoir would include a cup attached to a spigot or retractable straw, which, in turn, would be connected to the reservoir. The tubular reservoir includes a fluid compartment that can be tilled with drinking water for the animal. The band includes suitable fasteners at one end to secure the band around the pat's neck.

In another aspect of the present invention, the reservoir, without any additional attachments, would be capable of being worn by the dog. Alternatively, the reservoir could be removably attached to a dog collar having an identification tag used to identify the dog. The water reservoir would generally aid in the reduction of risk of dehydration from heat when water would not be readily available from other sources. Additionally, the present invention would eliminate the inconvenience of carrying or storing bulky water bottles. The reservoir can easily be detached from the dog collar, allowing for use as a traditional dog collar complete with an identification tag. Alternatively, the water reservoir can be attached to the dog through the use of a harness.

The present invention not only provides a source of clean drinking water for the pet, but also provides a suitable container from which the pet can drink. Since the pet carries its own water, its owner is not burdened. Moreover, the collar is more convenient to use than harnesses, which have been devised in the past. Furthermore, dogs and other pets are already accustomed to wearing a collar.

Another objective of the present invention is to provide a device that will be economical to manufacture and easy to implement.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and with the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

The invention will be better understood, and objectives other than those set forth above will become apparent, when consideration is given to the following detailed description thereof. Such description makes reference to the annexed drawings, wherein:

FIG. 1 is a perspective view of the combination dog collar and water reservoir worn by a dog;

FIG. 2 is a perspective view of the combination dog collar and water reservoir in the closed position;

FIG. 3 is a perspective view of the combination pet dog collar and water reservoir in the open position;

FIG. 4 is a side view showing an expandable cup attached to the water reservoir; and

FIG. 5 is a cutaway view of the expandable cup.

### DETAILED DESCRIPTION OF THE INVENTION

In the following detailed description, reference is made to the accompanying drawings, which form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized, and that structural, logical, and electrical changes may be made without departing from the spirit and scope of the present invention. The following detailed description is, therefore, not to be taken in a limiting sense, and the scope of the present invention is defined by the appended claims and their equivalents.

Referring now to the drawings, the combination water reservoir and pet collar 10 with a dispensing cup 26 is shown. The collar 10 is comprised of a tubular water reservoir made of a waterproof material. The tubular reservoir includes fluid compartments 20 that can be filled with drinking water for the animal. A cup 26 would be attached to one end of the dispensing member 24 through the use of a tether 38. The interior of the reservoir 12 is filled with a fluid, such as water, through one or more orifices 40 provided on the surface of the reservoir.

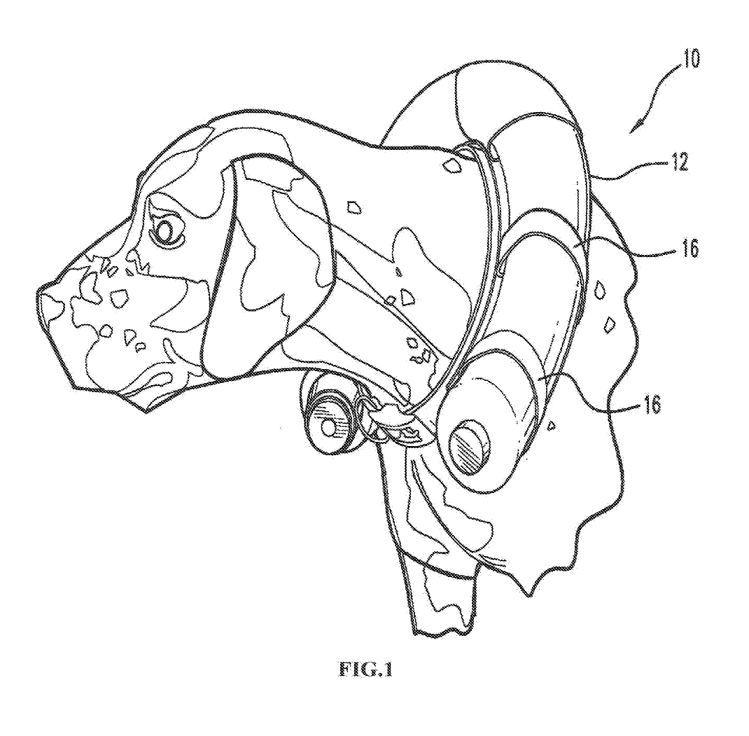

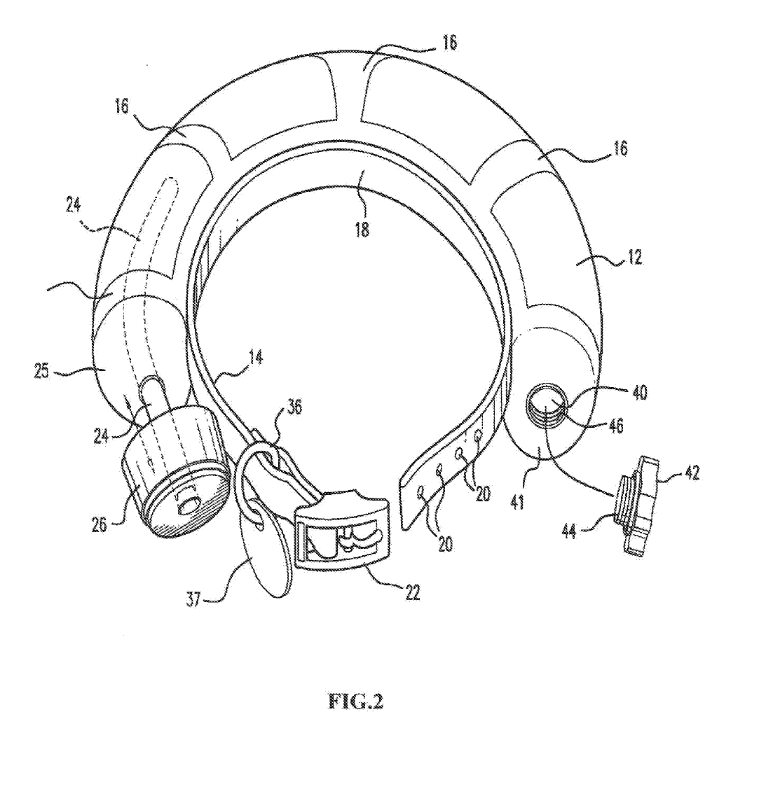

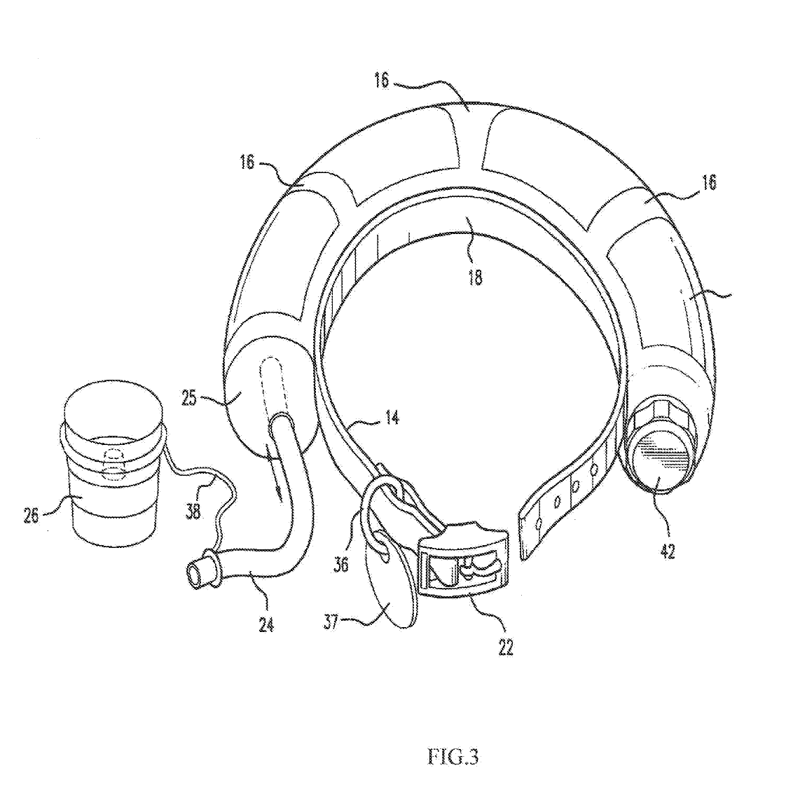

FIGS. 1-5 illustrate the combination pet collar and water reservoir 10 in more detail. Referring to FIG. 1, the combination pet collar and water reservoir 10 includes a water reservoir 12 that is secured to the neck of the dog. The water reservoir 12 is generally tubular in shape, and is formed from a plastic waterproof lining into which water or other types of fluids are introduced. The exterior of the water reservoir 12 can be formed from nylon or any other type of weather resistant and/or water resistant fabrics. A plurality of reflective strips 16 can be applied to the surface of the water reservoir 12. The purpose of these strips would be to provide additional safety for the dog or other pet, as well as the pet's owner. The reflective strips 16 can be affixed to the exterior of the water reservoir 12 in virtually any manner, such as reflective paint (see FIGS. 2 and 3), or be removable from the water reservoir 12 through the use of Velcro®-type strips (see FIG. 1). The water reservoir 12 is removably attached to a standard choke and harness type pet collar 14 through various attachment devices, such as Velcro®-type strips, provided both on the surface of the pet collar 14 as well as the surface of the water reservoir 12 (not shown). As can be appreciated, the water reservoir 12 and the pet collar 14 can come in various lengths and widths to accommodate differently sized dogs.

FIG. 2 illustrates the combination dog collar and water reservoir with the reservoir 12 filled with a fluid either just prior to the combination pet collar water reservoir being secured to the animal or just subsequent to the combination pet collar and reservoir 10 being removed from around the animal's neck. As shown in FIG. 2, the reservoir 12 is secured to the pet collar 14 utilizing any state-of-the-art fastening devices in a manner allowing the reservoir 12 to be removed from the pet collar 14. The pet collar 14 would include a plastic or leather strap 18 that has a buckle 22 at one end and a plurality of holes 20 at the opposite end, allowing the pet collar itself or in combination with the water reservoir 12 to be secured around the neck of the animal. An identification tag 36 is affixed in various manners to various portions of the strap 18 of the pet collar 14. A spigot-type dispensing member, such as a straw 24, would extend from one end 25 of the water reservoir 12. A cup 26 would be attached to one end of the dispensing member 24 through the use of a tether 38. The interior of the reservoir 12 is filled with a fluid, such as water, through one or more orifices 40 provided on the surface of the reservoir 12. As shown in FIG. 2, a single orifice is provided at the end 41 of the water reservoir 12. A removable cap 42 that has a screw-like projection 44 will cooperate with screw threads 46 to open and close the water reservoir 12. A tether could be provided between the interior of the end 41 in the cap 42 to prevent the toss of the cap 42 when it is removed from the reservoir 12. As shown in FIG. 2, the dispensing device 24, as well as the cup 26, are in the closed position. At this point, the combined water reservoir and dog collar can be secured to the dog's neck, as shown in FIG. 1.

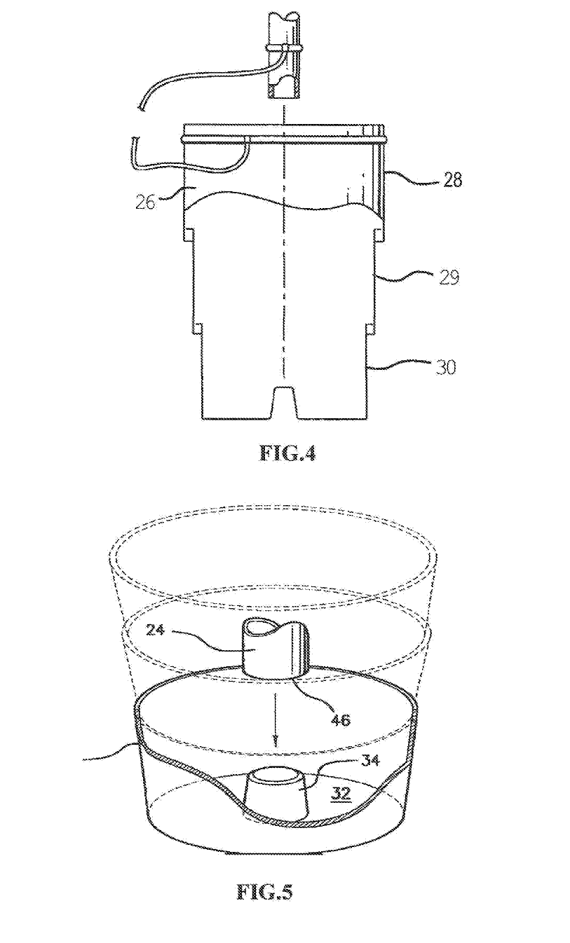

FIG. 3 shows the combination pet collar and water reservoir 10 in a position for dispensing water or other liquid from the interior of the reservoir 12. The dispensing device 24 could be an immovable straw that extends from the interior of the reservoir 12 in a manner that allows water to be dispensed into the cup 26. In this embodiment, a portion of the straw would initially extend into the interior of the reservoir 12. When in the dispensing mode, the cup 26, containing telescoping sections 28, 29 and 30 (see FIG. 4), would be removed from the dispensing device 24 in a manner that allows water or other fluid to be forced from the interior of the reservoir 12, through the dispensing device 24, and into the bottom 32 of the cup 26.

FIGS. 4 and 5 show various views of the dispensing device 24 and the cup 26. As shown therein, a small knob 34 is affixed to the bottom of the cup 32. When the combination pet collar and water reservoir is in the closed position, as illustrated in FIG. 2, the distal end 46 of the dispensing device 24 would be forced in the direction of the arrow included in FIG. 5 around the knob 34, thereby preventing water or other fluids from being dispensed from the device when the dispensing device is in the closed position. Based on the construction of the combination pet collar and reservoir 10, an animal can be easily and quickly hydrated during a long walk or hike. After the fluid has been introduced into the reservoir 12 through the top 40, the top 40 is closed, and the combination pet collar and water reservoir is secured around the neck of the dog, as shown in FIG. 1, with the combination put collar/water reservoir in the closed position, as illustrated in FIG. 2. Thereafter, at the appropriate time, the pet owner would pull the cup 26 away from the dispensing device 24 and extend the cup 26 to the position shown in FIG. 3. At this point if the dispensing device 24 is an extendable straw, the straw would be extended, and the owner would squeeze the reservoir 12, directing fluid therein to flow through the dispensing device 24 and into the cup 26. Obviously, if the dispensing device 24 is not extendable, once the cup is in the position shown in FIG. 4, the owner would squeeze the water reservoir, thereby directing fluid to flow from the reservoir through the dispensing device 24 and into the cup 26. At this point, the dog could easily lap the water provided within the cup 26. In this manner, the dog would become hydrated very quickly and without the necessity of removing the combination pet collar and water reservoir from around the neck of the dog. In addition, since the combination pet collar/water reservoir is provided with its own drinking cup or bowl, it would not be necessary to have the owner carry a separate water bowl during the long walk or hike.

As previously indicated, the water reservoir 12 is removable from the pet collar 14. Therefore, when it is not necessary to hydrate the dog, the pet collar 14 would be worn by the dog in the usual manner, without the water reservoir 12 being connected to the pet collar 14.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible, it is contemplated that these variations, modifications, additions, and improvements fall within the scope of the invention.

I claim:

1. A liquid receptacle and water reservoir in combination with a pet collar comprising:
a tubular shape water reservoir provided with a first orifice for filling said reservoir with fluid and a second orifice for dispensing the fluid from said reservoir,
a plurality of reflective strips applied to the surface of said water reservoir,
a standard choke and harness attachment provided for attaching said water reservoir with the body of an animal,
a spigot-type dispensing member provided from said second orifice for assisting the dispensing of the fluid from said water reservoir, and
a receptacle connecting to said dispensing device.

2. The water reservoir of claim 1, wherein said reservoir is formed from a plastic waterproof lining,

3. The water reservoir of claim 1, wherein the exterior of said water reservoir is formed from weather resistant and/or water resistant fabrics.

4. The water reservoir of claim 1 is further provided with a removable cap that has a screw-like projection to open and close said first orifice of said water reservoir.

5. The water reservoir of claim 1, wherein said reflective strips can be affixed to the exterior of said water reservoir through Velcro®-type strips.

6. The water reservoir of claim 1, wherein said attachment is a pet collar.

7. The water reservoir of claim 1, wherein said dispensing device is an extendable straw.

8. The water reservoir of claim 1, wherein said receptacle is a cup.

9. The water reservoir of claim 1 is further provided with an identification tag attached to said pet collar.

10. The water reservoir of claim 1, wherein said receptacle is provided with a knob cooperating with the distal end of said dispensing device to prevent a fluid from being dispensed from said reservoir when said receptacle is in its first position,

11. The water reservoir of claim 1, wherein said receptacle is connected to said dispensing device by a tether.

12. A method of hydrating an animal, comprising the steps of:
filling a flexible container provided with a dispensing device and a receptacle connected to the said dispensing device, with a fluid;
attaching said container to the animal;
disconnecting said receptacle from said dispensing device;
squeezing the exterior of said flexible container, thereby emptying a portion of the fluid from said container into said receptacle; and
presenting said receptacle with a fluid therein to the animal, thereby allowing the animal to drink the fluid, wherein said disconnecting step, said squeezing step and said presenting step performed with said container remaining attached to the animal

13. The method of hydrating an animal of claim 12, further including the step of moving said dispensing device from a first position predominately within said flexible container to a second position predominately outside of said flexible container prior to said squeezing step.

14. The method of claim 12, wherein said receptacle is a cup and further including the step of opening said cup from a closed position to an opened telescoped position prior to said squeezing step.
